(19) United States
(12) Patent Application Publication
(10) Pub. No.: US 2025/0259383 A1
(43) Pub. Date: Aug. 14, 2025

(54) GENERATING GRAPHICAL REPRESENTATIONS FOR VIEWING 3D DATA AND/OR IMAGE DATA

(71) Applicant: FARO Technologies, Inc., Lake Mary, FL (US)

(72) Inventor: Amodio PESCE, Rezzato, BS (IT)

(21) Appl. No.: 19/062,827

(22) Filed: Feb. 25, 2025

Related U.S. Application Data
(63) Continuation of application No. PCT/US23/33599, filed on Sep. 25, 2023.
(60) Provisional application No. 63/410,010, filed on Sep. 26, 2022.

(51) Int. Cl. G06T 17/00

(52) U.S. Cl. CPC G06T 17/00

(57) ABSTRACT

A method includes receiving three-dimensional (3D) data and image data. The method further includes generating a graphical representation based at least in part on at least one of the 3D data or the image data, the graphical representation including a first region selectively switchable between a single-sub-region mode and a multi-sub-region mode. Responsive to the single-sub-region mode being enabled, the first region displays at least a first portion of the 3D data or at least a first portion of the image data. Responsive to the multi-sub-region mode being enabled, the first region includes at least a first sub-region and a second sub-region. The first sub-region displays at least a second portion of the 3D data or at least a second portion of the image data, and the second sub-region displays at least a third portion of the 3D data or at least a third portion of the image data.

### CROSS-REFERENCE TO RELATED APPLICATIONS

This application is a continuation of PCT Application Serial Number PCT/US23/33599, filed Sep. 25, 2023, the contents of which are incorporated by reference herein in its entirety, and claims the benefit of U.S. Provisional Patent Application Ser. No. 63/410,010, filed Sep. 26, 2022, the contents of which are incorporated by reference herein in its entirety.

### BACKGROUND

The subject matter disclosed herein relates to use of a three-dimensional (3D) laser scanner time-of-flight (TOF) coordinate measurement device. A coordinate measurement device of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A laser scanner TOF coordinate measurement device (or simply “laser scanner”) is a scanner in which the distance to a target point is determined based on the speed of light in air between the scanner and a target point. Laser scanners are typically used for scanning closed or open spaces such as interior areas of buildings, industrial installations and tunnels. They may also be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Accordingly, while existing coordinate measurement devices are suitable for their intended purposes, what is needed is a coordinate measurement device having certain features of embodiments described herein.

### BRIEF DESCRIPTION

In one exemplary embodiment, a method is provided. The method includes receiving three-dimensional (3D) data associated with an environment. The method further includes receiving image data associated with the environment. The method further includes generating a graphical representation based at least in part on at least one of the 3D data and the image data, the graphical representation including a first region selectively switchable between a single-sub-region mode and a multi-sub-region mode. Responsive to the single-sub-region mode being enabled, the first region displays at least one of at least a first portion of the 3D data and at least a first portion of the image data. Responsive to the multi-sub-region mode being enabled, the first region includes at least a first sub-region and a second sub-region. The first sub-region displays at least one of at least a second portion of the 3D data and at least a second portion of the image data, and the second sub-region displays at least one of at least a third portion of the 3D data or at least a third portion of the image data.

According to an embodiment, a system is provided that includes a memory comprising computer readable instructions and a processing device for executing the computer readable instructions, the computer readable instructions controlling the processing device to perform operations. The operations include receiving three-dimensional (3D) data associated with an environment. The operations further include receiving image data associated with the environment. The operations further include generating a graphical representation based at least in part on at least one of the 3D data and the image data, the graphical representation comprising a first region selectively switchable between a single-sub-region mode and a multi-sub-region mode. Responsive to the single-sub-region mode being enabled, the first region displays at least one of at least a first portion of the 3D data and at least a first portion of the image data. Responsive to the multi-sub-region mode being enabled, the first region comprises at least a first sub-region and a second sub-region, the first sub-region displaying at least one of at least a second portion of the 3D data and at least a second portion of the image data, and the second sub-region displaying at least one of at least a third portion of the 3D data and at least a third portion of the image data.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a laser scanner according to one or more embodiments described herein;

FIG. 2 is a side view of the laser scanner illustrating a method of measurement according to one or more embodiments described herein;

FIG. 3 is a schematic illustration of the optical, mechanical, and electrical components of the laser scanner according to one or more embodiments described herein;

FIG. 4 is a schematic illustration of the laser scanner of FIG. 1 according to one or more embodiments described herein;

FIGS. 5A-5C depict a system for collecting and/or displaying images of an environment according to one or more embodiments described herein;

FIGS. 5D-5F depict images associated with the system of FIGS. 5A-5C;

FIG. 6 is a schematic illustration of a processing system for generating graphical representations for viewing 3D data and or image data according to one or more embodiments described herein;

FIG. 7 depicts a flow diagram of a method for graphical representation generation using 3D data and/or image data according to one or more embodiments described herein;

FIGS. 8A-8H depict graphical representations according to one or more embodiments described herein;

FIG. 9 depicts a block diagram of functional blocks of the processing system of FIG. 6 according to one or more embodiments described herein; and

FIG. 10 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Optical measurement devices use light to measure coordinates on surfaces in the environment. The raw scan data may be collected, stored and sent to a processor or processors to generate a 3D image representing the scanned area or object. Generating an image requires at least three values for each data point. These three values may include the distance and two angles, or may be transformed values, such as the x, y, z coordinates. In an embodiment, an image is also based on a fourth gray-scale value, which is a value related to irradiance of scattered light returning to the scanner.

Most laser scanner TOF coordinate measurement devices direct the beam of light within the measurement volume by steering the light with a beam steering mechanism. The beam steering mechanism includes a first motor that steers the beam of light about a first axis by a first angle that is measured by a first angular encoder (or another angle transducer). The beam steering mechanism also includes a second motor that steers the beam of light about a second axis by a second angle that is measured by a second angular encoder (or another angle transducer).

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

One application where coordinate measurement devices such as laser scanners are used is to scan an environment. Another application where coordinate measurement devices such as laser scanners are used is to scan an object.

One or more embodiments described herein relate generating graphical representations for viewing 3D data and/or image data.

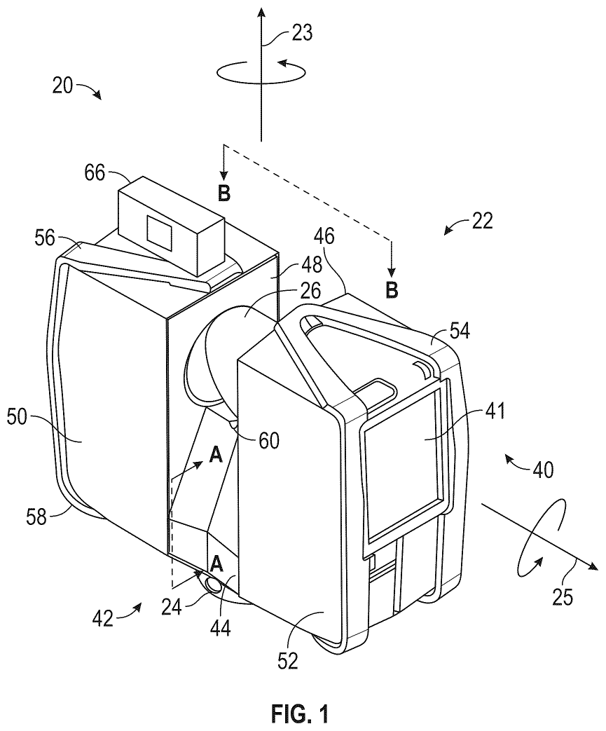

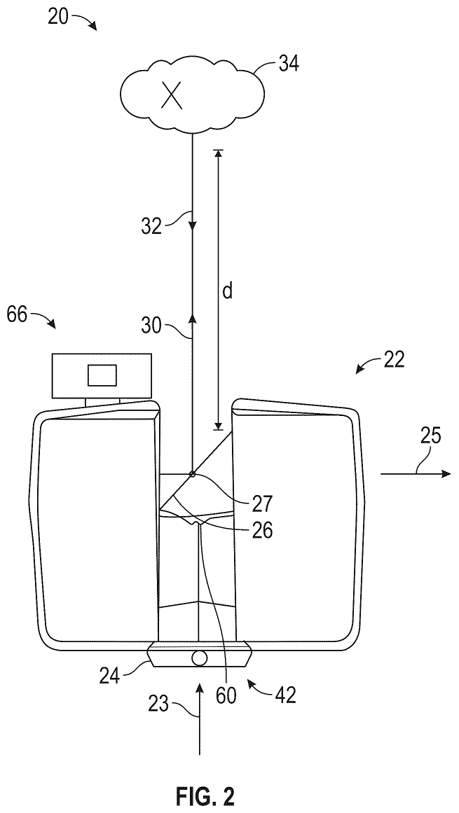

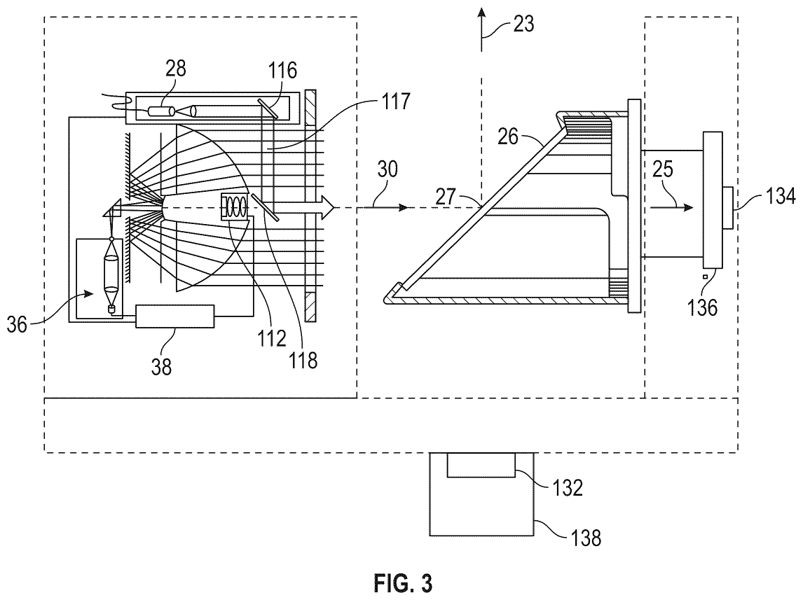

Referring now to FIGS. 1-3, a 3D coordinate measurement device, such as a laser scanner 20, is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 may be rotated about a vertical axis 23. In one embodiment, the measuring head 22 includes a gimbal point 27 that is a center of rotation about the vertical axis 23 and a horizontal axis 25. The measuring head 22 has a rotary mirror 26, which may be rotated about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, Cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the laser scanner 20 may also collect gray-scale information related to the received optical power (equivalent to the term “brightness.”) The gray-scale value may be determined at least in part, for example, by integration of the bandpass-filtered and amplified signal in the light receiver 36 over a measuring period attributed to the object point X.

The measuring head 22 may include a display device 40 integrated into the laser scanner 20. The display device 40 may include a graphical touch screen 41, as shown in FIG. 1, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d may depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 may be used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 (‘012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. The auxiliary image acquisition device 66 may be, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and may have the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 may be a near infrared laser light (for example, light at wavelengths of 780 nm or 1250 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the mirror 26 about the axis 25.

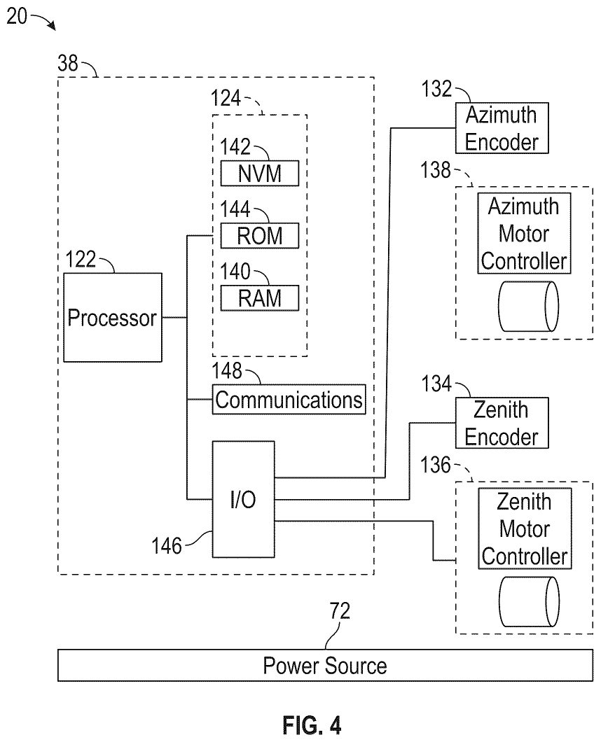

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors may be microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 may be displayed on a user interface 40 coupled to controller 38. The user interface 40 may be one or more LEDs (light-emitting diodes) 82, an LCD (liquid-crystal diode) display, a CRT (cathode ray tube) display, a touch-screen display or the like. A keypad may also be coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 may also be coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet (\hat{ }) Protocol), RS-232, ModBus, and the like. Additional laser scanners 20 may also be connected to LAN with the controllers 38 in each of these laser scanners 20 being configured to send and receive data to and from remote computers and other laser scanners 20. The LAN may be connected to the Internet. This connection allows controller 38 to communicate with one or more remote computers connected to the Internet.

The processors 122 are coupled to memory 124. The memory 124 may include random access memory (RAM) device 140, a non-volatile memory (NVM) device 142, and a read-only memory (ROM) device 144. In addition, the processors 122 may be connected to one or more input/output (I/O) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while embodiments herein describe the 3D coordinate measurement device as being a laser scanner, this is for example purposes and the claims should not be so limited. In other embodiments, the 3D coordinate measurement device may be another type of system that measures a plurality of points on surfaces (i.e., generates a point cloud), such as but not limited to a triangulation scanner, a structured light scanner, or a photogrammetry device for example.

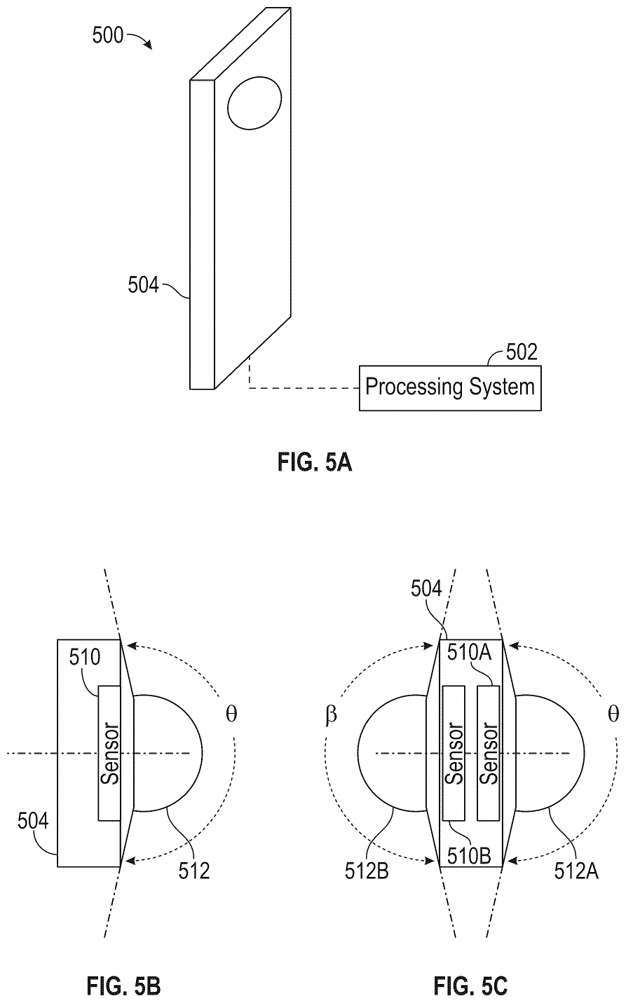

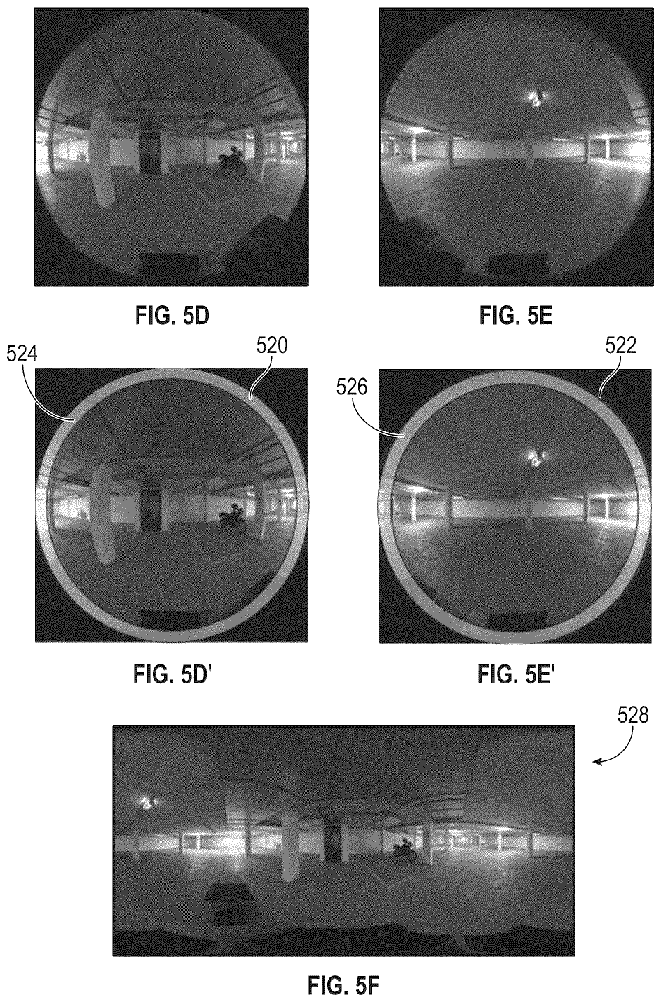

Referring now to FIGS. 5A-5C, an embodiment is shown of a system 500 for collecting and/or displaying images of an environment according to one or more embodiments described herein. Particularly, FIG. 5A depicts the system 500 to collect and/or display images of an environment or object, the system 500 having a camera 504 and a processing system 502.

The processing system 502 can be any suitable processing system, such as a smartphone, tablet computer, laptop or notebook computer, node(s) of a cloud computing system, etc. Although not shown, the processing system 502 can include one or more additional components, such as a processor for executing instructions, a memory for storing instructions and/or data, a display for displaying user interfaces, an input device for receiving inputs, an output device for generating outputs, a communications adapter for facilitating communications with other devices (e.g., the camera 504), and/or the like including combinations and/or multiples thereof.

The camera 504 captures one or more images, such as a panoramic image, of an environment. In examples, the camera 504 can be an ultra-wide angle camera. As an example, the camera 504 can be an omnidirectional camera, such as the RICO THETA camera. In an embodiment, the camera 504 includes a sensor 510 (FIG. 5B), that includes an array of photosensitive pixels. The sensor 510 is arranged to receive light from a lens 512. In the illustrated embodiment, the lens 512 is an ultra-wide angle lens that provides (in combination with the sensor 510) a field of view θ between 100 and 270 degrees, for example. In an embodiment, the field of view θ is greater than 180 degrees and less than 270 degrees about a vertical axis (e.g., substantially perpendicular to the floor or surface that the measurement device is located). It should be appreciated that while embodiments herein describe the lens 512 as a single lens, this is for example purposes and the lens 512 may be a comprised of a plurality of optical elements.

In an embodiment, the camera 504 includes a pair of sensors 510A, 510B that are arranged to receive light from ultra-wide angle lenses 512A, 512B respectively (FIG. 5C). In this example, the camera 104 can be referred to as a dual camera because it has a pair of sensors 510A, 510B and lenses 512A, 512B as shown. The sensor 510A and lens 512A are arranged to acquire images in a first direction, and the sensor 510B and lens 512B are arranged to acquire images in a second direction. In the illustrated embodiment, the second direction is opposite the first direction (e.g., 180 degrees apart). A camera having opposingly arranged sensors and lenses with at least 180 degree field of view are sometimes referred to as an omnidirectional camera, a 360 degree camera, or a panoramic camera as it acquires an image in a 360 degree volume about the camera.

FIGS. 5D and 5E depict images acquired by the dual camera of FIG. 5C, for example, and FIGS. 5D′ and 5E′ depict images acquired the dual camera of FIG. 5C where each of the images has a field of view greater than 180 degrees. It should be appreciated that when the field of view is greater than 180 degrees, there will be an overlap 120, 122 between the acquired images 124, 126 as shown in FIG. 5D′ and FIG. 5E′. In some embodiments, the images may be combined to form a single image 528 of at least a substantial portion of the spherical volume about the camera 504 as shown in FIG. 5F.

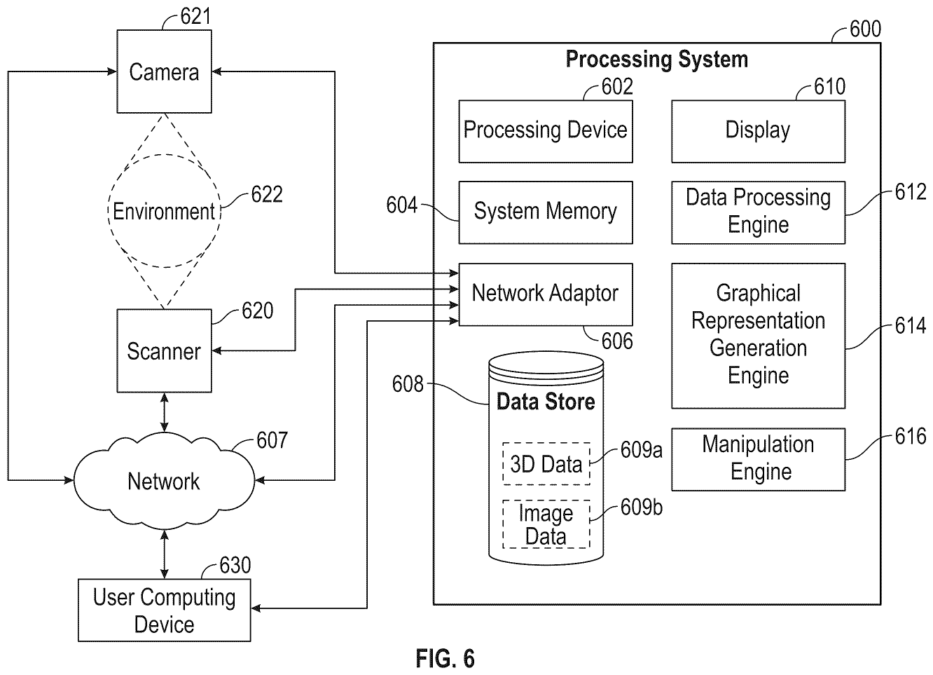

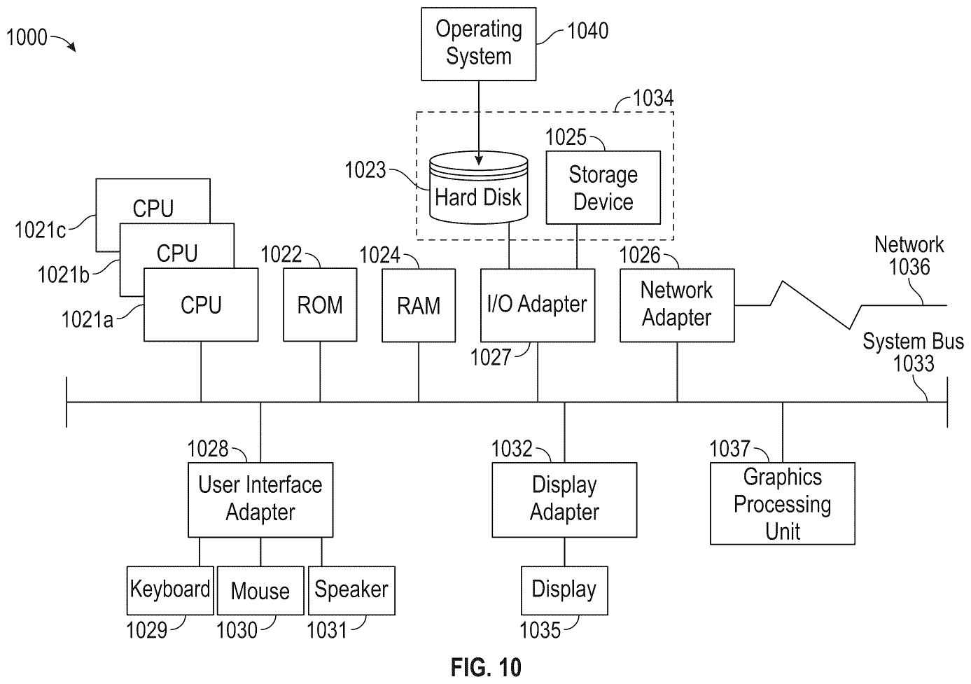

FIG. 6 is a schematic illustration of a processing system 600 for generating graphical representations for viewing 3D data and or image data according to one or more embodiments described herein. The processing system 600 includes a processing device 602 (e.g., one or more of the processing devices 1021 of FIG. 10), a system memory 604 (e.g., the RAM 1024 and/or the ROM 1022 of FIG. 10), a network adapter 606 (e.g., the network adapter 1026 of FIG. 10), a data store 608, a display 610, a data processing engine 612, a graphical representation generation engine 614, and manipulation engine 616. According to one or more embodiments described herein, the processing system 600 is an example of the processing system 502 of FIG. 5A. The processing system 600 can be any suitable processing system, such as a smartphone, tablet computer, laptop or notebook computer, node(s) of a cloud computing system, etc.

The various components, modules, engines, etc. described regarding FIG. 6 (e.g., the data processing engine 612, the graphical representation generation engine 614, and the manipulation engine 616) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 602 for executing those instructions. Thus, the system memory 604 can store program instructions that when executed by the processing device 602 implement the engines described herein. Other engines can also be utilized to include other features and functionality described in other examples herein.

The network adapter 606 enables the processing system 600 to transmit data to and/or receive data from other sources, such as the scanner 620 and/or the camera 621. For example, the processing system 600 receives data (e.g., a data set that includes a plurality of three-dimensional coordinates of an environment 622) from the scanner 620 directly and/or via a network 607. The data from the scanner 620 can be stored in the data store 608 of the processing system 600 as 3D data 609a, which can be used to display a point cloud or other graphical representation on the display 610. The scanner 620 can be the same or similar to the scanner 20 of FIGS. 1-4 according to one or more embodiments described herein. According to one or more embodiments described herein, the camera 621 can capture images of the environment 622, which may be presented on the display 610 as a video stream of the environment 622, as a panoramic and/or 360 degree view of the environment 622, and/or the like, including combinations and/or multiples thereof. The images of the environment 622 captured by the camera 621 can be transmitted from the camera 621 to the processing system 600 directly and/or via the network 607 and can be stored in the data store 608 as image data 609b. The camera 621 can be the same or similar to the camera 504 of FIGS. 5A-5C according to one or more embodiments described herein.

The network 607 represents any one or a combination of different types of suitable communications networks such as, for example, cable networks, public networks (e.g., the Internet), private networks, wireless networks, cellular networks, or any other suitable private and/or public networks. Further, the network 607 can have any suitable communication range associated therewith and may include, for example, global networks (e.g., the Internet), metropolitan area networks (MANs), wide area networks (WANs), local area networks (LANs), or personal area networks (PANs). In addition, the network 607 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The scanner 620 (e.g., a laser scanner) can be arranged on, in, and/or around the environment 622 to scan the environment 622. It should be appreciated that while embodiments herein refer to a 3D coordinate measurement device as a laser scanner (e.g., the scanner 620), this is for example purposes and the claims should not be so limited. In other embodiments, other types of optical measurement devices may be used, such as but not limited to triangulation scanners and structured light scanners for example.

According to one or more embodiments described herein, the scanner 620 can include a scanner processing system including a scanner controller, a housing, and a three-dimensional (3D) scanner. The 3D scanner can be disposed within the housing and operably coupled to the scanner processing system. The 3D scanner includes a light source, a beam steering unit, a first angle measuring device, a second angle measuring device, and a light receiver. The beam steering unit cooperates with the light source and the light receiver to define a scan area. The light source and the light receiver are configured to cooperate with the scanner processing system to determine a first distance to a first object point based at least in part on a transmitting of a light by the light source and a receiving of a reflected light by the light receiver. The 3D scanner is further configured to cooperate with the scanner processing system to determine 3D coordinates of the first object point based at least in part on the first distance, a first angle of rotation, and a second angle of rotation.

The scanner 620 performs at least one scan to generate a data set (e.g., the 3D data 609a) that includes a plurality of three-dimensional coordinates of the environment 622. It should be appreciated that other numbers of scanners (e.g., one scanner, three scanners, four scanners, six scanners, eight scanners, etc.) can be used. According to one or more embodiments described herein, one or more scanners can be used to take multiple scans. For example, the scanner 620 can capture first scan data of the environment 622 at a first location and then be moved to a second location, where the scanner 620 captures second scan data of the environment 622.

Using the data received from the scanner 620, the processing system 600 can generate a graphical representation based on the 3D data 609a and/or the image data 609b (e.g. point data) using one or more of the data processing engine 612, the graphical representation generation engine 614, and/or the manipulation engine 616. For example, the data processing engine 612 performs processing on the data 609a and/or the data 609b. Examples of data processing include removing/reducing noise within the data, extracting features from the data, identifying changes in the data over time, adding annotations to data, measuring aspects of the data (e.g., a distance between two points), comparing aspects of the data, and/or the like, including combinations and/or multiples thereof. The graphical representation generation engine 614 generates a graphical representation of the data 609a and/or the data 609b for display on the display 610 and/or on a display of another device/system. For example, in an embodiment where the processing system 600 is a node of a cloud computing system, the graphical representation generation engine 614 can generate a graphical representation to be displayed on a user computing device 630 (e.g., such as a smartphone, tablet computer, laptop or notebook computer, a wearable device such as a head-up display or smartwatch, and/or the like, including combinations and/or multiples thereof).

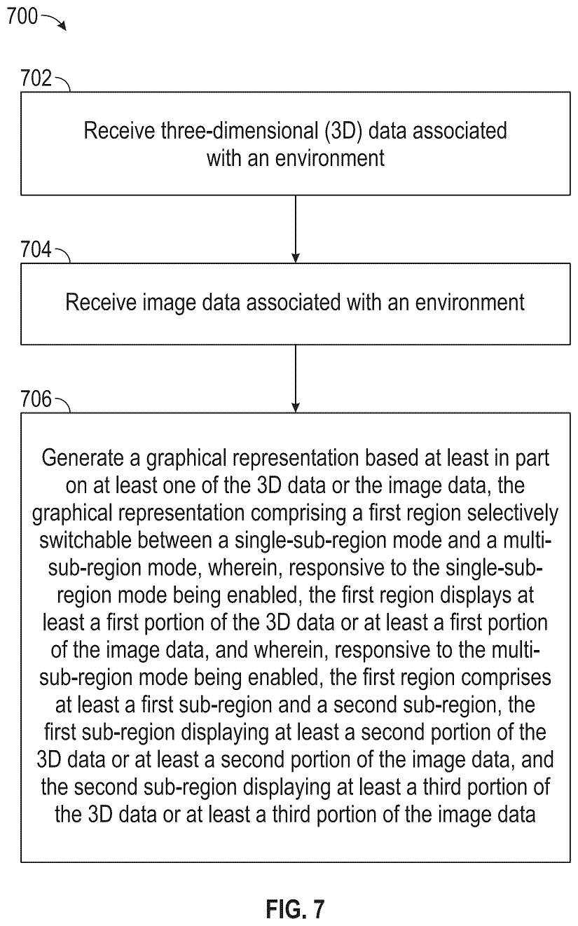

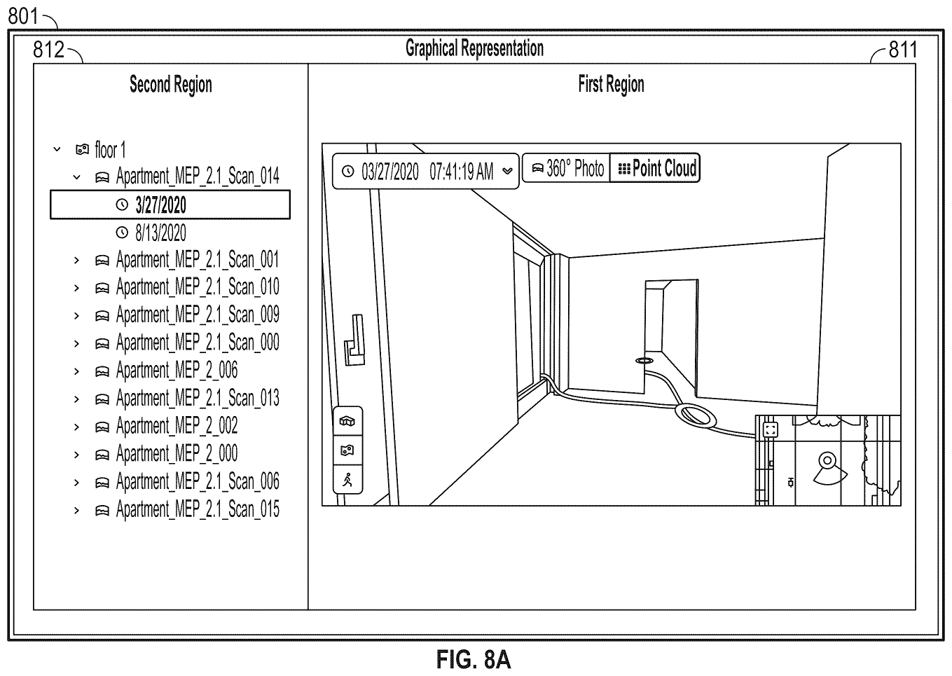

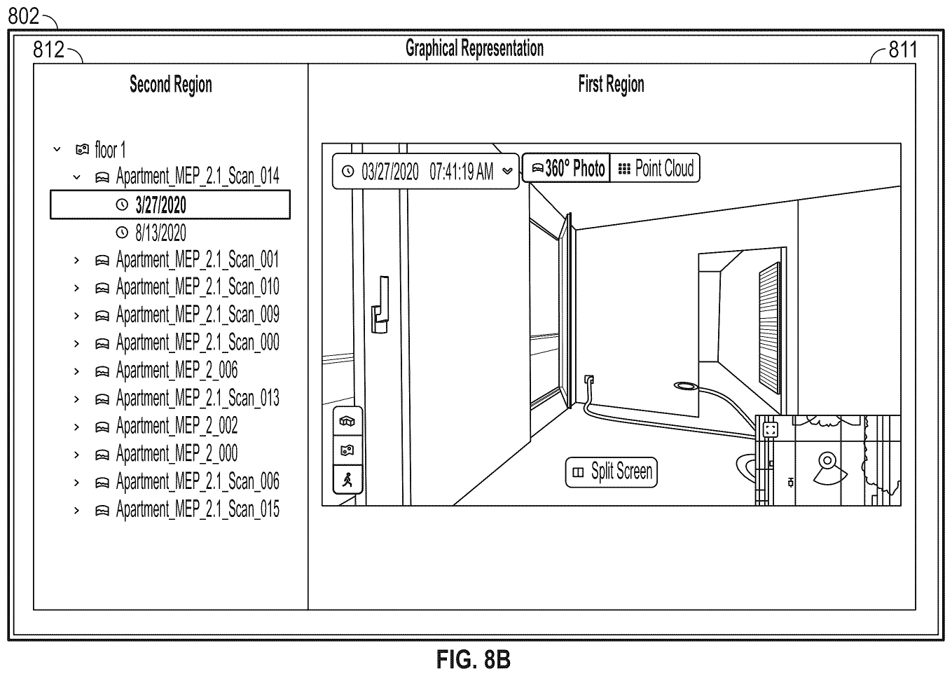

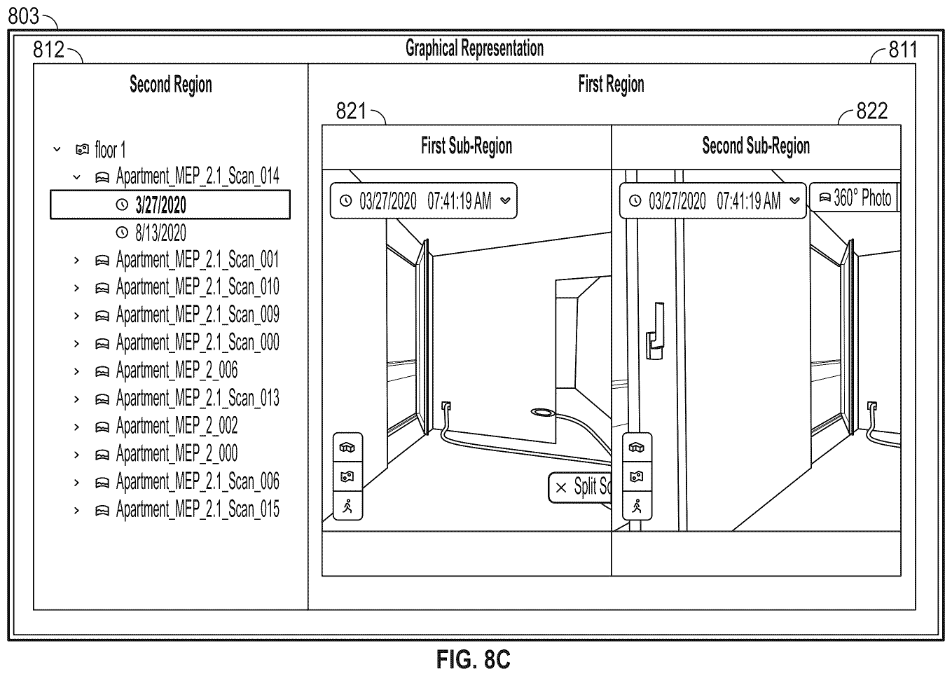

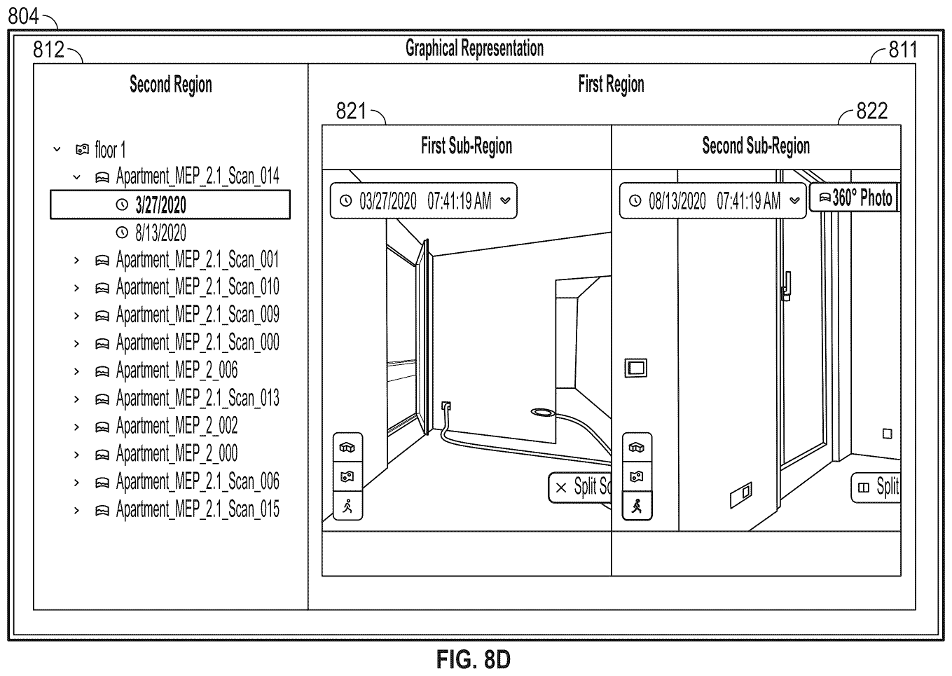

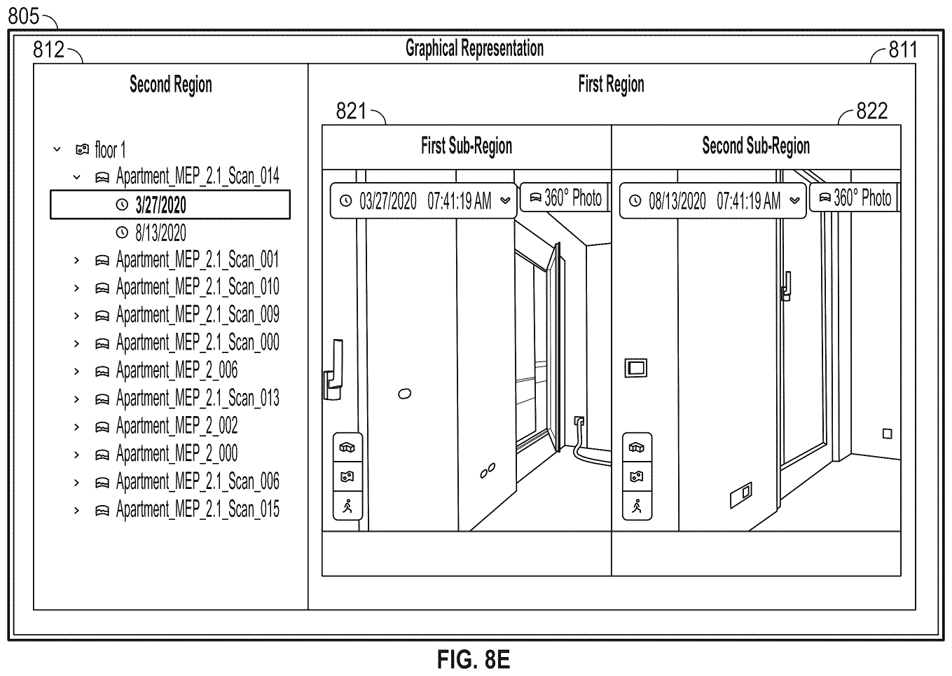

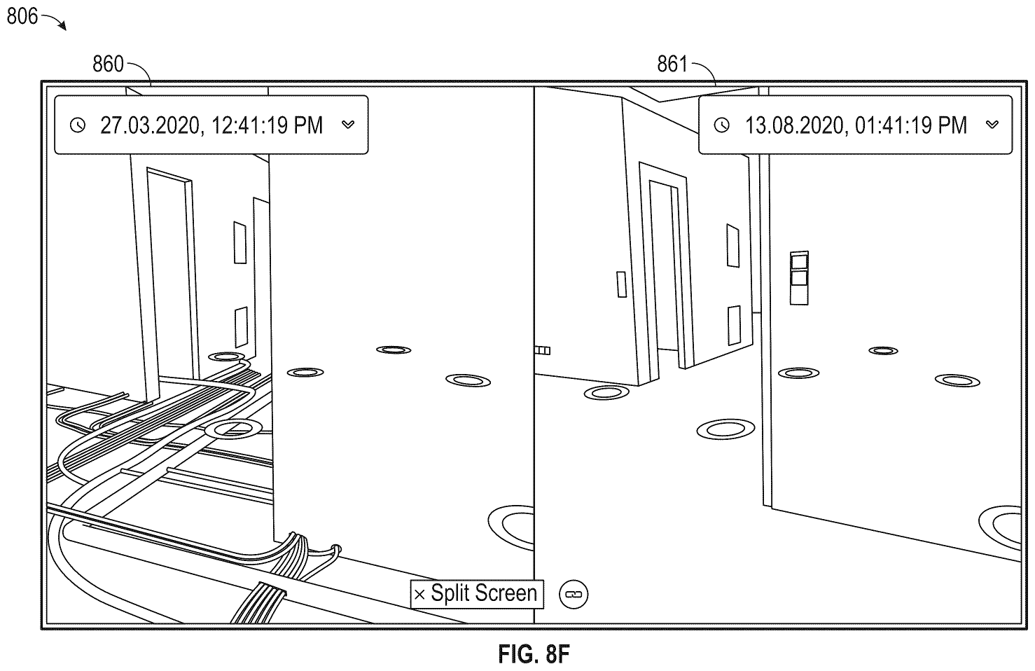

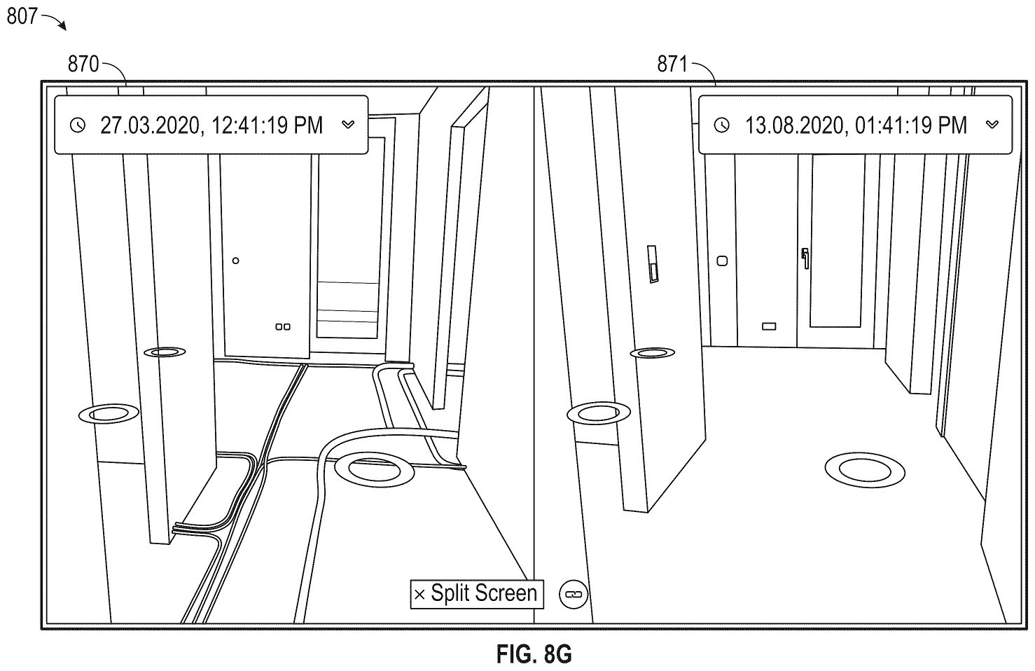

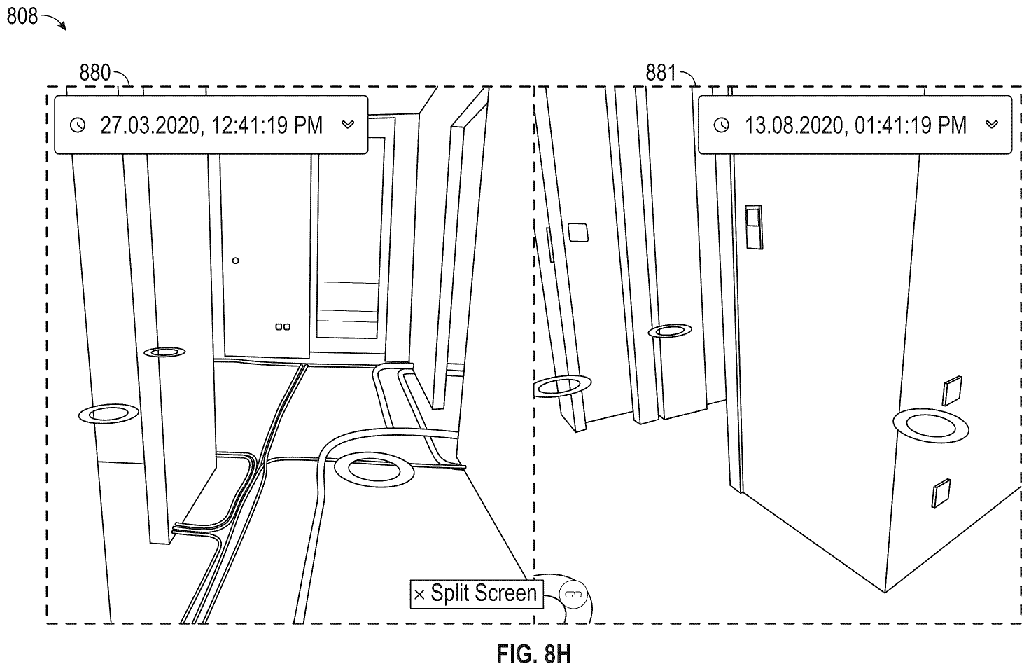

According to one or more embodiments described herein, the graphical representation generation engine 614 can generate a split-screen view of the data 609a, 609b. For example, the graphical representation generation engine 614 can generate a graphical display that displays at least a portion of the data 609a and/or the data 609b separately as is further described herein. Particularly, the features and functions of the engines 612, 614, 616 are now described in more detail with reference to FIGS. 7 and 8A-8H as examples.

Turning now to FIG. 7, a flow diagram of a method 700 for graphical representation generation using 3D data and/or image data according to one or more embodiments described herein. The method 700 can be performed by any suitable system or device, such as the processing system 503 of FIG. 5, the processing system 600 of FIG. 6, and/or the processing system 1000 of FIG. 10. The method 700 is now described with further reference to FIGS. 8A-8H.

At block 702, a processing system (e.g., the processing system 600) receives 3D data (e.g., 3D data 609a) associated with an environment (e.g., the environment 622). The 3D data 609a can be captured by any suitable 3D coordinate measurement device, such as the scanner 20 of FIGS. 1-4, the scanner 620 of FIG. 6, and/or the like, including combinations and/or multiples thereof. According to an embodiment, the 3D data 609a includes one or more point clouds, which are collections of points having 3D coordinates (e.g., “x,y,z”) associated with the environment.

At block 704, the processing system (e.g., the processing system 600) receives image data (e.g., image data 609b) associated with the environment (e.g., the environment 622). The image data 609b can be captured by any suitable camera device, such as the camera 504 of FIG. 5, the camera 621 of FIG. 6, and/or the like, including combinations and/or multiples thereof. According to an embodiment, the image data 609b includes one or more images. According to one or more embodiments described herein, the one or more images can be one or more 360 degree images, panoramic images, and/or the like, including combinations and/or multiples thereof, which are associated with the environment.

At block 706, the processing system (e.g., using the graphical representation generation engine 614) generates a graphical representation. The graphical representation can be based at least in part on the 3D data, the image data, a combination of the 3D data and the image data, and/or the like, including combinations and/or multiples thereof. FIGS. 8A-8E depict example graphical representation 801-805 according to one or more embodiments described herein.

In these examples, the graphical representations 801-805 include a first region 811 that can be used to display 3D data (e.g., the 3D data 609a) and/or image data (e.g., the image data 609b). According to one or more embodiments described herein, the field of view of the 3D data and/or the image data displayed in the first region 811 can be defined by a user and can be adjusted while the user is viewing the graphical representations 801-805. As the user adjusts a field of view, the 3D data and/or the image data displayed in the first region 811 can correspondingly adjust in some embodiments or can be fixed in some embodiments.

According to one or more embodiments described herein, the first region 811 is selectively switchable between a single-sub-region mode and a multi-sub-region mode. For example, a user can select a “split screen” option to divide the first region 811 into multiple sub-regions.

FIGS. 8A and 8B depict the single-sub-region mode and FIGS. 8C-8E depict the multi-sub-region mode. In FIG. 8A, the first region 811 of the graphical representation 801 represents a single-sub region and displays 3D data in the form of a point cloud. In FIG. 8B, the first region 811 of the graphical representation 802 also represents a single-sub region, but in this example, the first region 811 displays image data as a portion of a 360 degree image.

In the examples of FIGS. 8C-8E, the first region 811 is switched to a multi-sub-region mode having two sub-regions. It should be appreciated that the first region 811 can have additional sub-regions in other embodiments and is not limited to the two illustrated sub-regions. In FIGS. 8C-8E, the first region 811 is divided into a first sub-region 821 and a second sub-region 822. In FIG. 8C, the first sub-region 821 displays image data and the second sub-region 822 displays 3D data in the form of a point cloud. In this example, the first and second sub-regions 821, 822 show the respective image and 3D data that were captured at substantially the same time as shown. However, in other examples, different times can be selected to show how the environment changed over time. For example, in FIG. 8D, the first sub-region 821 displays image data captured at a first point in time and the second sub-region 822 displays image data captured at a second point in time. A comparison between the images shows differences in the environment that occurred over time. In FIG. 8D, the first sub-region 821 displays 3D data in the form of a point cloud captured at a first point in time and the second sub-region 822 displays 3D data in the form of a point cloud captured at a second point in time. Again, differences in the environment between the two points in time can be observed.

According to one or more embodiments described herein, the graphical representations 801-805 can also include a second region 812. According to one or more embodiments described herein, the second region 812 displays information associated with the 3D data and/or the image data, such as a location of the environment at which the 3D data and/or the image data were captured, a timestamp associated with when the 3D data and/or the image data were captured, and/or the like, including combinations and/or multiples thereof.

FIGS. 8F-8H depict additional example graphical representations 806-808. Regarding FIG. 8F, the graphical representation 806 depicts an image 860 captured at a first point in time and an image 861 captured at a second point in time. A user, using the manipulation engine 616, can manipulate the images 860, 861. For example, a user may want to compare change to the environment relative to the first and second points in time. When the user moves the field of view of the image 860, the field of view for the image 861 also moves. This is referred to as a dependent linking mode. For example, when the user manipulates one of the images 860, 861, the field of view of the other image also moves, as shown in the graphical representation 807 of FIG. 8G. That is, when the user manipulates one of the images 860, 861 of the graphical representation 806 by changing the field of view, the graphical representation 806 is generated, showing images 870, 871. Particularly, the graphical representation 807 depicts an image 870 captured at the first point in time and the image 871 captured at the second point in time.

According to an embodiment, the user may desire to inspect details from multiple locations or points of view. In such cases, the fields of view of the images 870, 871 can move independently in an independent linking mode. To select between dependent moving and independent moving, the user can select a “linking” option on the graphical representation. When independent moving is selected, the user can move the fields of view of each of the images 870, 871 independently to generate the graphical representation 808 shown in FIG. 8H.

According to an embodiment, a hybrid linking approach may be implemented, which is now described with reference to FIG. 8H. Particularly, the graphical representation 808 of FIG. 8H depicts an image 880 captured at the first point in time and the image 881 captured at the second point in time. In this example, the image 880 is a “main” view where adjusting a field of view of the image 880 also adjusts the field of view of the image 881. However, the field of view of the image 881 can be moved independently such that when the user adjusts the field of view of the image 881, the field of view of the image 880 does not move.

According to one or more embodiments described herein, each of the images 880, 881 of two split screens of FIG. 8H shows a spherical view of the 360/panorama image. Also, each of the images 880, 881 contains capture location markers (e.g., shown on the “floor” of the environment in the images) that indicate other capture locations. Clicking, by a user, on one of the capture location markers does causes one or more of the following to occur. If clicked on a marker in the left split screen (e.g., the image 880), the virtual user walks in both split screens, satisfying the use case of time comparisons of adjacent locations. If clicked on a marker in the right split screen (e.g., the image 881), the virtual user only walks in the right split screen. This provides for users to compare the same objects from different camera angles, either in the same time point or at different time points.

Adjusting the field of view of an image, as described herein, can include one or more of panning the image, tilting the image, rotating the image, moving “through” the environment digitally, zooming in/out, and/or the like, including combinations and/or multiples thereof.

One or more embodiments described herein provide for independently rotating the two views. One or more embodiments described herein provides for independently translating one view relative to the other. For example, clicking on an icon in the left view causes the two views to rotate together while clicking on the right icon causes the right view to be moved and rotated independently of the first. Clicking on the left icon again causes to two images to rotate synchronously, but now seen from different perspectives. In this way, a user may view two different sides of an environment or view two different environments in the split screen.

It should be understood that the process depicted in FIG. 7 represents an illustration, and that other processes may be added or existing processes may be removed, modified, or rearranged without departing from the scope of the present disclosure.

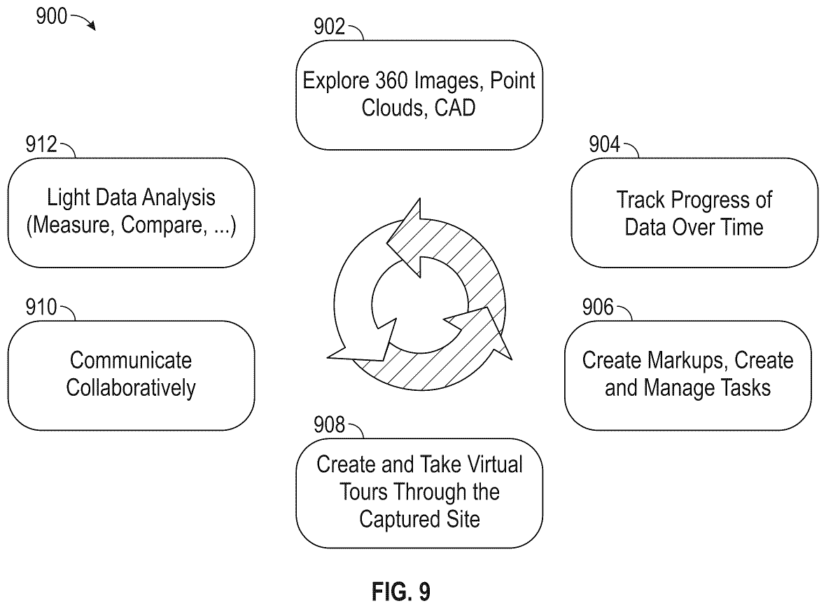

FIG. 9 depicts a block diagram of functional blocks 900 of the processing system 600 of FIG. 6 according to one or more embodiments described herein. One or more of the functional blocks 900 can be performed by the processing system 600, such as using the data processing engine 612, or another suitable system, device, or engine. At functional block 902, the data processing engine 612 can provide for a user to explore 360 images, point clouds, computer-aided design (CAD) models, building information modeling (BIM) models, and/or the like, including combinations and/or multiples thereof, such as using one or more of the graphical representations 801-808 in FIGS. 8A-8H.

At functional block 904, the data processing engine 612 can track the progress of data over time. For example, the data 609a, 609b can have associated timestamps when the data is captured, and the data processing engine 612 can process changes to the data, and thus the environment, over time.

At functional block 906, the data processing engine 612 can provide for annotating the data 609a, 609b. For example, the data can be annotated by creating markups, creating and managing tasks, and/or the like, including combinations and/or multiples thereof.

At functional block 908, the data processing engine 612, in conjunction with the graphical representation generation engine 614, can provide for a user to create and take virtual tours through an environment (e.g., captured site) associated with the data 609a, 609b.

At functional block 910, the data processing engine 612 can provide for the user to communicate collaboratively with another user(s), such as by sharing some or all of the data 690a, 609b, sharing a virtual tour from functional block 908, sharing annotations from block 906, and/or the like, including combinations and/or multiples thereof.

At functional block 912, the data processing engine 612 perform data analysis, such as performing measuring, comparing, and/or the like, including combinations and/or multiples thereof, as described herein.

It should be appreciated that the functional blocks 900 are merely examples of functions that the processing system 600 can perform, and the processing system 600 is not limited to these functions as other functions can be added in different embodiments.

It is understood that one or more embodiments described herein is capable of being implemented in conjunction with any other type of computing environment now known or later developed. For example, FIG. 10 depicts a block diagram of a processing system 1000 for implementing the techniques described herein. In accordance with one or more embodiments described herein, the processing system 1000 is an example of a cloud computing node of a cloud computing environment. In examples, processing system 1000 has one or more central processing units (“processors” or “processing resources” or “processing devices”) 1021a, 1021b, 1021c, etc. (collectively or generically referred to as processor(s) 1021 and/or as processing device(s)). In aspects of the present disclosure, each processor 1021 can include a reduced instruction set computer (RISC) microprocessor. Processors 1021 are coupled to system memory (e.g., random access memory (RAM) 1024) and various other components via a system bus 1033. Read only memory (ROM) 1022 is coupled to system bus 1033 and may include a basic input/output system (BIOS), which controls certain basic functions of processing system 1000.

Further depicted are an input/output (I/O) adapter 1027 and a network adapter 1026 coupled to system bus 1033. I/O adapter 1027 may be a small computer system interface (SCSI) adapter that communicates with a hard disk 1023 and/or a storage device 1025 or any other similar component. I/O adapter 1027, hard disk 1023, and storage device 1025 are collectively referred to herein as mass storage 1034. Operating system 1040 for execution on processing system 1000 may be stored in mass storage 1034. The network adapter 1026 interconnects system bus 1033 with an outside network 1036 enabling processing system 1000 to communicate with other such systems.

A display (e.g., a display monitor) 1035 is connected to system bus 1033 by display adapter 1032, which may include a graphics adapter to improve the performance of graphics intensive applications and a video controller. In one aspect of the present disclosure, adapters 1026, 1027, and/or 1032 may be connected to one or more I/O busses that are connected to system bus 1033 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1033 via user interface adapter 1028 and display adapter 1032. A keyboard 1029, mouse 1030, and speaker 1031 may be interconnected to system bus 1033 via user interface adapter 1028, which may include, for example, a Super I/O chip integrating multiple device adapters into a single integrated circuit.

In some aspects of the present disclosure, processing system 1000 includes a graphics processing unit 1037. Graphics processing unit 1037 is a specialized electronic circuit designed to manipulate and alter memory to accelerate the creation of images in a frame buffer intended for output to a display. In general, graphics processing unit 1037 is very efficient at manipulating computer graphics and image processing, and has a highly parallel structure that makes it more effective than general-purpose CPUs for algorithms where processing of large blocks of data is done in parallel.

Thus, as configured herein, processing system 1000 includes processing capability in the form of processors 1021, storage capability including system memory (e.g., RAM 1024), and mass storage 1034, input means such as keyboard 1029 and mouse 1030, and output capability including speaker 1031 and display 1035. In some aspects of the present disclosure, a portion of system memory (e.g., RAM 1024) and mass storage 1034 collectively store the operating system 1040 to coordinate the functions of the various components shown in processing system 1000.

In addition to one or more of the features described herein, or as an alternative, further embodiments of the method may include that the graphical representation further includes a second region, wherein the second region displays information associated with the 3D data and the image data.

In addition to one or more of the features described herein, or as an alternative, further embodiments of the method may include that the 3D data and the image data are temporally linked.

In addition to one or more of the features described herein, or as an alternative, further embodiments of the method may include that, in an independent linking mode, a field of view of the first sub-region can be changed independently of a field of view of the second sub-region.

In addition to one or more of the features described herein, or as an alternative, further embodiments of the method may include that, in a dependent linking mode, a field of view of the first sub-region changes according to a change to a field of view of the second sub-region.

In addition to one or more of the features described herein, or as an alternative, further embodiments of the method may include that, in a hybrid linking mode, a field of view of the first sub-region can be changed independently of a field of view of the second sub-region and the field of view of the second sub-region changes according to a change to the field of view of the first sub-region.

In addition to one or more of the features described herein, or as an alternative, further embodiments of the method may include that the 3D data includes a point cloud.

In addition to one or more of the features described herein, or as an alternative, further embodiments of the method may include that the image data includes a 360 degree image.

In addition to one or more of the features described herein, or as an alternative, further embodiments of the method may include that the first portion of the 3D data was captured at a first point in time and the at least the first portion of the image data was captured at a second point in time.

In addition to one or more of the features described herein, or as an alternative, further embodiments of the method may include that the at least the second portion of the 3D data or the least the second portion of the image data were captured at a first point in time, and wherein the at least the third portion of the 3D data or the least the third portion of the image data were captured at a second point in time.

In addition to one or more of the features described herein, or as an alternative, further embodiments of the system may include that the graphical representation further comprises a second region, wherein the second region displays information associated with the 3D data and the image data.

In addition to one or more of the features described herein, or as an alternative, further embodiments of the system may include that the 3D data and the image data are temporally linked.

In addition to one or more of the features described herein, or as an alternative, further embodiments of the system may include that, in an independent linking mode, a field of view of the first sub-region can be changed independently of a field of view of the second sub-region.

In addition to one or more of the features described herein, or as an alternative, further embodiments of the system may include that, in a dependent linking mode, a field of view of the first sub-region changes according to a change to a field of view of the second sub-region.

In addition to one or more of the features described herein, or as an alternative, further embodiments of the system may include that, in a hybrid linking mode, a field of view of the first sub-region can be changed independently of a field of view of the second sub-region and the field of view of the second sub-region changes according to a change to the field of view of the first sub-region.

In addition to one or more of the features described herein, or as an alternative, further embodiments of the system may include that the 3D data comprises a point cloud.

In addition to one or more of the features described herein, or as an alternative, further embodiments of the system may include that the image data comprises a 360 degree image.

In addition to one or more of the features described herein, or as an alternative, further embodiments of the system may include that the first portion of the 3D data was captured at a first point in time and the at least the first portion of the image data was captured at a second point in time.

In addition to one or more of the features described herein, or as an alternative, further embodiments of the system may include that the at least the second portion of the 3D data or the least the second portion of the image data were captured at a first point in time, and wherein the at least the third portion of the 3D data or the least the third portion of the image data were captured at a second point in time.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method comprising:
receiving three-dimensional (3D) data associated with an environment;
receiving image data associated with the environment; and
generating a graphical representation based at least in part on at least one of the 3D data and the image data, the graphical representation comprising a first region selectively switchable between a single-sub-region mode and a multi-sub-region mode,
wherein, responsive to the single-sub-region mode being enabled, the first region displays at least one of at least a first portion of the 3D data and at least a first portion of the image data, and
wherein, responsive to the multi-sub-region mode being enabled, the first region comprises at least a first sub-region and a second sub-region, the first sub-region displaying at least one of at least a second portion of the 3D data and at least a second portion of the image data, and the second sub-region displaying at least one of at least a third portion of the 3D data and at least a third portion of the image data.

2. The method of claim 1, wherein the graphical representation further comprises a second region, wherein the second region displays information associated with the 3D data and the image data.

3. The method of claim 1, wherein the 3D data and the image data are temporally linked.

4. The method of claim 1, wherein, in an independent linking mode, a field of view of the first sub-region can be changed independently of a field of view of the second sub-region.

5. The method of claim 1, wherein, in a dependent linking mode, a field of view of the first sub-region changes according to a change to a field of view of the second sub-region.

6. The method of claim 1, wherein, in a hybrid linking mode, a field of view of the first sub-region can be changed independently of a field of view of the second sub-region and the field of view of the second sub-region changes according to a change to the field of view of the first sub-region.

7. The method of claim 1, wherein the 3D data comprises a point cloud.

8. The method of claim 1, wherein the image data comprises a 360 degree image.

9. The method of claim 1, wherein the first portion of the 3D data is captured at a first point in time and the at least the first portion of the image data is captured at a second point in time.

10. The method of claim 1, wherein the at least one of the at least the second portion of the 3D data and the least the second portion of the image data are captured at a first point in time, and wherein the at least one of the at least the third portion of the 3D data and the least the third portion of the image data are captured at a second point in time.

11. A system, comprising:
a memory comprising computer readable instructions; and
a processing device for executing the computer readable instructions, the computer readable instructions controlling the processing device to perform operations comprising:
receiving three-dimensional (3D) data associated with an environment;
receiving image data associated with the environment; and
generating a graphical representation based at least in part on at least one of the 3D data and the image data, the graphical representation comprising a first region selectively switchable between a single-sub-region mode and a multi-sub-region mode,
wherein, responsive to the single-sub-region mode being enabled, the first region displays at least one of at least a first portion of the 3D data and at least a first portion of the image data, and
wherein, responsive to the multi-sub-region mode being enabled, the first region comprises at least a first sub-region and a second sub-region, the first sub-region displaying at least one of at least a second portion of the 3D data and at least a second portion of the image data, and the second sub-region displaying at least one of at least a third portion of the 3D data and at least a third portion of the image data.

12. The system of claim 11, wherein the graphical representation further comprises a second region, wherein the second region displays information associated with the 3D data and the image data.

13. The system of claim 11, wherein the 3D data and the image data are temporally linked.

14. The system of claim 11, wherein, in an independent linking mode, a field of view of the first sub-region can be changed independently of a field of view of the second sub-region.

15. The system of claim 11, wherein, in a dependent linking mode, a field of view of the first sub-region changes according to a change to a field of view of the second sub-region.

16. The system of claim 11, wherein, in a hybrid linking mode, a field of view of the first sub-region can be changed independently of a field of view of the second sub-region and the field of view of the second sub-region changes according to a change to the field of view of the first sub-region.

17. The system of claim 11, wherein the 3D data comprises a point cloud, and wherein the image data comprises a 360 degree image.

18. The system of claim 11, wherein the first portion of the 3D data is captured at a first point in time and the at least the first portion of the image data is captured at a second point in time.

19. The system of claim 11, wherein the at least one of the at least the second portion of the 3D data and the least the second portion of the image data are captured at a first point in time, and wherein the at least one of the at least the third portion of the 3D data and the least the third portion of the image data are captured at a second point in time.

20. A system, comprising:
at least one camera that captures image data associated with an environment;
at least one scanner that captures three-dimensional (3D) data associated with the environment;
a data store for storing the image data associated with the environment captured with the at least one camera, and the 3D data associated with the environment captured with the at least one scanner;
a processing system that generates a graphical representation based at least in part on at least one of the 3D data and the image data, the graphical representation comprising a first region selectively switchable between a single-sub-region mode and a multi-sub-region mode,
wherein, responsive to the single-sub-region mode being enabled, the first region displays on a display of a user computing device at least one of at least a first portion of the 3D data and at least a first portion of the image data, and
wherein, responsive to the multi-sub-region mode being enabled, the first region comprises at least a first sub-region and a second sub-region, the first sub-region displaying on the display of the user computing device at least one of at least a second portion of the 3D data and at least a second portion of the image data, and the second sub-region displaying on the display of the user computing device at least one of at least a third portion of the 3D data and at least a third portion of the image data.
